(19) United States
(12) Patent Application Publication
(10) Pub. No.: US 2014/0372300 A1
(43) Pub. Date: Dec. 18, 2014

(54) SMART CARD ELECTRONIC WALLET SYSTEM

(71) Applicant: Simon Blythe, Cambridgeshire (GB)

(72) Inventor: Simon Blythe, Cambridgeshire (GB)

(21) Appl. No.: 13/918,383

(22) Filed: Jun. 14, 2013

(51) Int. Cl. G06Q 20/36

(52) U.S. Cl. CPC G06Q 20/3676
USPC 705/41

(57) ABSTRACT

Methods, systems and apparatus for conducting offline transactions utilizing an electronic wallet that includes a reserve purse and a separate received purse. In an embodiment, the process includes a payment device receiving a value for use in conducting offline transactions from an issuer bank computer, and then storing the value in a reserve purse of an electronic wallet. The method also includes receiving a second value from a second payment device, and storing the second value in a received purse of the electronic wallet. The payment device is operable to transmit at least a portion of the value stored in the reserve purse to a merchant device to consummate an offline purchase transaction or to a consumer payment device to consummate an offline payment transaction. The second value can be transferred from the received purse to the reserve purse only when the payment device goes online to an issuer bank.

### FIELD OF THE INVENTION

Embodiments disclosed herein generally relate to electronic cash apparatus, systems and methods, and in particular to an electronic wallet having a reserve purse and a separate received purse. The monetary value stored in the reserve purse may be utilized to conduct purchase transactions and payment transactions, but in some embodiments the monetary value of received payments which are stored in the received purse can only be realized after the electronic device containing the electronic wallet goes online with a financial institution to reconcile payments.

### BACKGROUND

Proximity payment devices are in widespread use. A well known standard for proximity payment devices has been promulgated by MasterCard International Incorporated, the assignee hereof, and is referred to as “PayPass™”. A proximity payment device is an electronic device that typically includes a wireless communication interface to transmit a payment account number and/or other information to, for example, a reader device associated with a merchant device such as a point of sale (POS) terminal. These wireless communication payment cards are sometimes referred to as “contactless” payment cards, and the wireless interface often includes a radio frequency identification integrated circuit (RFID IC) and an antenna to receive a power signal from and/or to transmit data to the reader device of the POS terminal. It has also been proposed to wirelessly exchange information using a NFC (Near Field Communication) protocol.

An example of a payment system is “Mondex”, in which currency is stored in smart cards which incorporate an integrated circuit (IC) and a storage device. Such smart cards or payment cards may be similar in shape and size to payment cards such as credit cards or debit cards, and generally permit the storage of sums of money up to several hundred dollars. Mondex was conceived as a way to overcome the expense of transporting and protecting large amounts of cash and, in cases supporting offline transactions, the cash value of received payments can be reused to pass on to future payees. In particular, in some implementations money or value may be electronically transferred from one consumer's Mondex card to other consumers' Mondex cards arbitrarily many times and in any chosen amounts. There is no concern about coin sizes, as with traditional currency, and the Mondex system provides a limited amount of anonymity. However, the Mondex system carries with it one of the disadvantages of physical currency, which is that if a Mondex card is lost or stolen, then the money stored therein is also lost. Transfers of funds from a first Mondex card to a second Mondex card may be conducted with any one of a range of intermediate hardware devices, such as reader devices associated with point of sale (POS) terminals.

The Mondex system relies for its security on a combination of cryptography and tamper-resistant hardware. For example, the protocol for transferring funds from one Mondex card to another may include utilizing digital signatures. The Mondex system also assumes that users cannot tamper with their cards to, for example, access and alter the balances stored in the storage or memory devices of their cards.

Other types of payment systems utilize IC payment cards which may be interfaced to a point-of-sale (POS) terminal via contacts on the card. During a purchase transaction, the payment card account number and other information may be uploaded from the IC payment card to the POS terminal via the IC card contacts and a contact card reader associated with the POS terminal. For example, the consumer or IC payment card user may be directed to physically “tap” his or her IC payment card on a specific contact surface associated with the card reader so that data will be transferred. Authorization and clearing may then proceed in substantially the same manner as for a transaction initiated with a conventional credit card or debit card having a magnetic stripe (putting aside additional security measures that may be implemented by using the processing capabilities of the IC payment card).

Conventional payment system purchase transactions that require real-time on-line communication with the account issuer—for the purpose of authorization or (in a “one message” system) for immediate charge against the customer's account—are sometimes referred to as “on-line” transactions. However, some payment card account issuers are willing to allow certain classes of transactions (e.g., transactions for small monetary amounts) to be consummated for later clearing without obtaining authorization from the issuer's computer while the transaction is pending between the merchant and the customer. In these transactions, the merchant's device (for example, a POS terminal) is not required to engage in communications with a payment system or with the issuer's computer system while the transaction is taking place, and these transactions are accordingly sometimes referred to as “offline” transactions. For such offline transactions, issuers typically consider the risk of a relatively small loss to fraud as being outweighed by the need to speed up purchase transactions for the convenience of customers and merchants.

In general, issuers of payment card accounts are concerned with “risk management” and with providing consumers with a convenient and easy to use payment card account product. Risk management refers to the balancing of the risk of loss due to fraud or over-spending with the costs and inconvenience that may be required for measures that may be undertaken to deter or prevent fraudulent transactions or over-spending. The above-noted practices relating to requiring real-time authorization for some transactions while not requiring such authorization for other transactions are examples of applications of the principles of risk management. The present inventors have now devised additional novel risk management techniques that are especially suitable for application with payment-enabled mobile devices and/or IC payment cards.

### BRIEF DESCRIPTION OF THE DRAWINGS

Features and advantages of some embodiments of the present invention, and the manner in which the same are accomplished, will become more readily apparent upon consideration of the following detailed description of the invention taken in conjunction with the accompanying drawings, which illustrate exemplary embodiments and which are not necessarily drawn to scale, wherein:

FIG. 1 is a schematic block diagram illustrating a wireless transaction device according to an embodiment of the invention;

FIG. 2 is a schematic block diagram of a payment enabled mobile telephone according to an embodiment of the invention;

FIG. 3 is a block diagram of a transaction handling system according to an embodiment of the invention;

FIG. 4 is a table illustrating examples of data associated with the reserve purse and the received purse of particular consumer's electronic wallet with regard to various types of transactions according to an embodiment of the invention;

FIG. 5 is a flowchart that illustrates a process for requesting loading of monetary value and/or the transfer of monetary value to a reserve purse of an electronic wallet of a consumer according to an embodiment of the invention;

FIG. 6 is a flowchart that illustrates a process for conducting a payment transaction by transmitting a monetary value from a reserve purse of a consumer's electronic wallet to a merchant device according to an embodiment;

FIG. 7 is a schematic block diagram illustrating a wireless transaction device according to an alternate embodiment of the invention; and

FIG. 8 is a flowchart that illustrates a process for conducting an offline payment transaction according to an embodiment of the invention.

### DETAILED DESCRIPTION

In general, and for the purpose of introducing concepts of embodiments, described are methods and/or systems in which the value of any received payments for an electronic wallet on a consumer's device can only be realized once the consumer's device goes online to an issuer financial institution or issuer bank. For example, an electronic wallet may be an application running on a smart phone or on a custom, ruggedized hardware device of the consumer, and the electronic wallet includes two purses to hold monetary value that is not exchangeable for cash or a cash equivalent while the electronic device is offline. Monetary value to spend is held in a reserve purse and received monetary value is stored in a received purse. The monetary value cannot be transferred between the reserve purse and the received purse of an electronic wallet on the same hardware device without involving the banking system. The hardware device does not need to be online in order for a payment to be made from the reserve purse or received and stored in the received purse, but must be online to realize the monetary value of a payment in the received purse via a reconciliation process.

In some embodiments, a consumer or customer loads the reserve purse with monetary value by using his or her hardware device (such as a payment enabled mobile telephone or an IC payment card) to communicate with a financial institution via a secure communication channel based on a technology appropriate to the country or region concerned. In an offline purchase transaction, the consumer pays for goods or services in an amount proportional to the monetary value of the merchandise or services by transferring monetary value from the reserve purse of the payer's electronic wallet to the received purse of the payee's electronic wallet (which may be, for example, a merchant's mobile device including a merchant electronic wallet, a POS terminal, or other suitable merchant device).

A first consumer with a first consumer payment device may also receive payment from a second consumer having a second consumer device with a second electronic wallet by conducting an offline payment transaction. In particular, the first consumer device receives payment from the reserve purse of the second electronic wallet into his or her received purse on the first electronic payment device to consummate the offline payment transaction. In order for the first consumer to realize the monetary value that is stored in the received purse, he or she can transfer that monetary value to the reserve purse of the electronic wallet of the first consumer device by going online. In this manner, the monetary value that was received (in the received purse), which belongs to the payee's issuing bank, can be reconciled with the acquiring bank of the first consumer's electronic wallet and then loaded into the reserve purse. Alternately, the first consumer can realize the monetary value in the received purse of his electronic wallet by going online and having that monetary value credited to the first consumer's financial account (in the first consumer's acquiring bank) through a reconciliation process with the payee's (the second consumer's) issuing bank.

A number of terms will be used herein. The use of such terms are not intended to be limiting, but rather are used for convenience and ease of exposition. For example, as used herein, the term “consumer” may be used interchangeably with the term “customer” and/or “cardholder” and are used herein to refer to a consumer, individual, business or other entity that has been issued (or authorized to use) a financial account such as a credit or debit account. The financial account may be accessed by use of a “payment device” such as a chip card (such as an EMV card) or an RFID card (such as a PayPass™ card). Pursuant to some embodiments, as used herein, the term “payment card” or “payment device” may also include a mobile device (such as a mobile telephone) operating a payment application that includes stored payment account information. In addition, the term “offline transaction” as used herein may refer to one or both of an offline payment transaction and/or an offline purchase transaction.

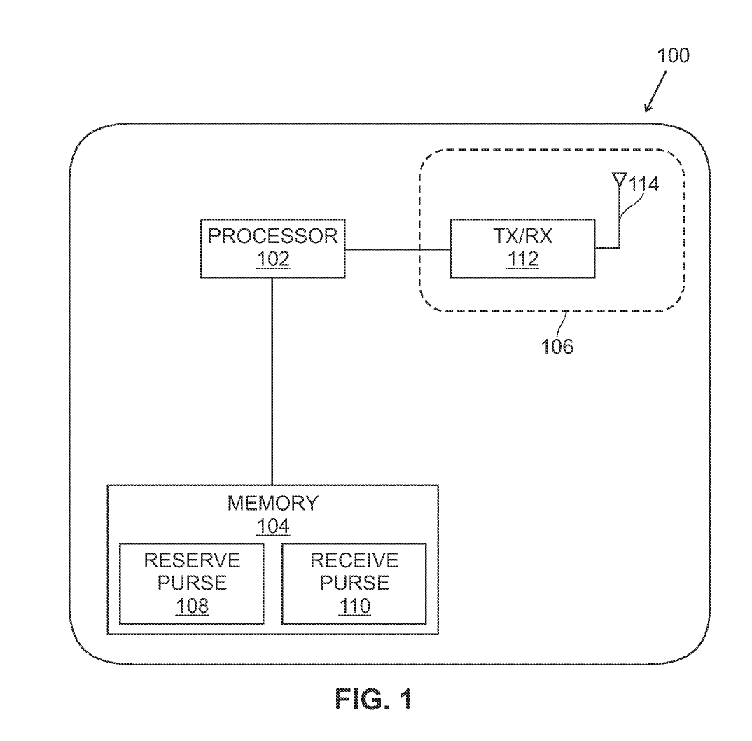

FIG. 1 illustrates is a schematic block diagram of a proximity payment device 100 according to some embodiments. The proximity payment device 100 may be sized and shaped like a conventional credit card or debit card, and may be made out of plastic or another type of material or of a composite material. Referring to FIG. 1, the proximity payment device 100 includes a processor 102, at least one storage device 104, and a wireless communication interface 106. The storage device 104 may comprise any appropriate information storage device, including combinations of storage devices, for example, a magnetic tape and/or semiconductor memory devices (such as Random Access Memory (RAM) devices and Read Only Memory (ROM) devices) and/or flash memory. Thus, the storage device 104 may be any suitable computer readable medium and/or any form of computer readable media capable of storing data, and in some implementations may also be capable of storing or configured to store non-transitory computer instructions and/or application programs which are executable by a processor.

Referring again to FIG. 1, in some embodiments the storage device 104 includes memory space that is partitioned into a reserve purse 108 and a received purse 110. The reserve purse 108 is operable to store value in an amount of a predefined currency and may be utilized by a consumer to purchase goods or services, or may be used to transfer an amount of currency to another consumer. The received purse 110 is operable to store value received from other entities, such as an amount of currency from another consumer. The storage device 104 is also configured to store a payment account number and/or other information required for entering into transactions, for example, a purchase transaction with a POS terminal of a merchant. In addition, the storage device may store one or more application programs and/or computer-readable instructions configured to instruct the processor to perform functions in accordance with the methods described herein. In some embodiments, the processor 102 may be a secure microcontroller. The reserve purse 106 and received purse 108 may also be contained within one or more secure storage portions of the storage device 104. The processor may also be configured to execute one or more pre-defined mobile payment device programs or applications stored within the storage device 104.

The wireless communication interface 106 allows the proximity payment device 100 to transmit and/or to receive signals. The signals transmitted by the wireless communication interface 106 may include a payment account number and/or other information stored in the memory or storage device 104. The signals received by the wireless communication interface may include an interrogation signal, a power signal and/or other signals. In some embodiments, the wireless communication interface 106 may be configured to allow the proximity payment device 100 to operate in accordance with the above-mentioned “PayPass™” standard.

In some embodiments, wireless communication interface 106 includes transmit/receive circuitry 112 and an antenna 114. The antenna 114 may be configured to transmit and receive radio frequency (RF) signals and may comprise a loop antenna and/or any other suitable configuration. The transmit/receive circuitry 112 may be coupled between the antenna 114 and the processor 102.

In operation, wireless signals (for example, RF signals) may be received by the antenna 114 and supplied to the transmit/receive circuitry 112, which in response may provide signals that are supplied to the processor 102. The processor 102 may also provide signals that are supplied to the transmit/receive circuitry 112, which in response may provide signals that are supplied to the antenna 114 for wireless transmission to, for example, a reader device associated with a POS terminal.

In some embodiments, the processor 102, storage device 104 and the transmit/receive circuitry 112 are disposed in a single integrated circuit (IC), and in some embodiments form a radio frequency identification (RFID) IC. For example, the processor 102, storage device 104 and transmit/receive circuitry 112 may be disposed in an IC that uses NFC technology, such as an NFC IC provided by PHILIPS ELECTRONICS or NXP Semiconductors.

Unless stated otherwise, the term RFID is not limited to a specific type of RFID. In some embodiments, an RFID may be a memory device capable only of responding to a pre-defined set of commands. In some other embodiments, an RFID may comprise a microcontroller capable of executing a program. Some embodiments may include further features and/or may comprise other configurations altogether. In some embodiments, the RFID IC comprises an IC that uses contactless technology.

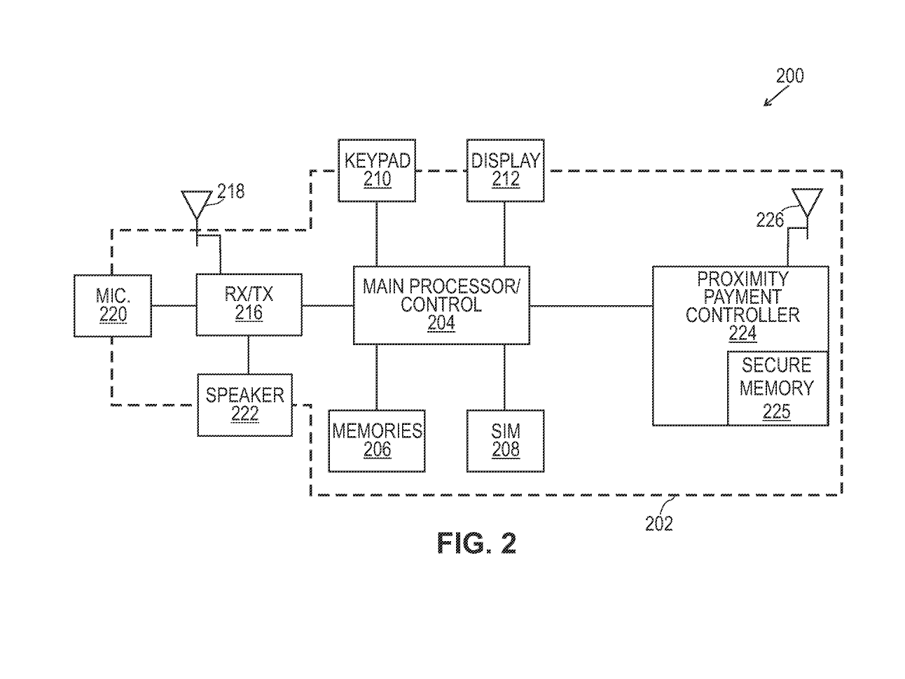

FIG. 2 is a schematic block diagram of an example embodiment of a payment enabled mobile telephone 200 according to an embodiment. It should be understood that FIG. 2 does not necessarily represent the physical layout of the payment enabled mobile telephone and that, in some of its hardware aspects the payment enabled mobile telephone 200 may be entirely conventional.

The payment enabled mobile telephone 200 may include a conventional housing (indicated by dashed line 202 in FIG. 2) that contains and/or supports the other components and/or circuitry. The payment enabled mobile telephone further includes conventional control circuitry 204, for controlling the over-all operation of the mobile telephone. Other components that are in communication with and/or controlled by the control circuitry 204, include: (a) one or more secure memory devices 206 (e.g., program and working memory, etc.); (b) a conventional subscriber identification module (SIM) card 208; (c) a conventional keypad 210 for receiving user input; and (d) a conventional display component 212 for displaying output information to the user. In some embodiments, the display component 212 may be a touch screen operable to both receive user input and display information to the user.

The payment enabled mobile telephone 200 also includes conventional receive/transmit circuitry 216 that is also in communication with and/or controlled by the control circuitry 204. The receive/transmit circuitry 216 is coupled to an antenna 218 and provides the communication channel(s) by which the payment enabled mobile telephone communicates via a mobile network (not shown). The payment enabled mobile telephone further includes a conventional microphone 220 for receiving voice input from the user, which is coupled to the receive/transmit circuitry 216. In addition, a loudspeaker 222 is included to provide sound output to the user, and is also coupled to the receive/transmit circuitry 216.

In conventional fashion, the receive/transmit circuitry 216 operates to transmit, via the antenna 218, voice signals generated by the microphone 220, and operates to reproduce, via the loudspeaker 222, voice signals received via the antenna 218. The receive/transmit circuitry 216 may also handle transmission and reception of text messages and/or other data communications via the antenna 218, which may be displayed to the user on the display 212.

The payment enabled mobile telephone 200 also includes an integrated circuit (IC) or chipset 224 of the kind embedded in contactless payment cards, such as the contactless payment card of FIG. 1. The IC/chipset 224 may also be referred to as a “payment circuit”. In some embodiments, the payment circuit 224 includes a secure memory (data storage) component 225 for storing a contactless payment application program and as well as information that is specific to a payment card account which has been issued to the individual who owns the payment enabled mobile telephone 200. In accordance with novel aspects described herein, the secure memory 225 may also include a reserve purse (not shown) for storing value associated with a predetermined currency of an amount that the consumer may spend, and may include a received purse (not shown) for storing value associated with the predetermined currency that the consumer has received from one or more entities. The reserve purse and received purse are configured such that they are separate from one another. In some embodiments, the secure memory 225 is partitioned to provide separate reserve purse and received purse memory portions that are configured such that transfers cannot be made directly from the received purse to the reserve purse, or vice-versa. In some implementations, the controller 224 is configured or programmed such that direct transfers cannot be made from the received purse to the reserve purse, or vice-versa. The secure memory 225 may comprise any appropriate information storage device, such as magnetic tape, a hard disk drive, an optical storage device (such as a compact disc (CD) and/or DVDs), and/or semiconductor memory devices such as Random Access Memory (RAM) devices and Read Only Memory (ROM) devices, as well as flash memory. Thus, the secure memory 225 may be any suitable computer readable medium and/or any form of computer readable media capable of storing data, and in some implementations may also be capable of storing or configured to store non-transitory computer instructions and/or application programs which are executable by the processor 204 and/or the proximity payment controller 224.

Referring again to FIG. 2, the payment enabled mobile telephone 200 includes a loop antenna 226 coupled to the payment circuit 224. In some embodiments, the loop antenna 226 and payment circuit 224 may operate so as to interact with an RFID and/or an NFC proximity reader of a POS terminal to function as described herein. In particular, the payment circuit 224 operates to provide the payment card account number (which may be stored in the secure memory 225), for example, to a reader device associated with a POS terminal to conduct a purchase transaction, and thus operates to transmit value from the reserve purse to the reader device. In addition, the payment circuit 224 operates to receive value from the consumer's issuer financial institution (or from another source, such as a payment enabled device of another consumer) and to store the received value in the received purse (which may be contained within the secure memory 225), as explained below.

Thus, the payment-enabled mobile telephone 200 of FIG. 2 includes the capabilities of a contactless payment card such that the mobile telephone can also be utilized as a contactless payment device. It should be understood that, in various implementations, a contactless portable payment device may be provided in other form factors, such as key fobs, wristwatches, wristbands and stickers. In addition, mobile devices other than mobile telephones, such as tablet computers, laptop computers, e-Book readers (such as the iPad® mini, Kindle Fire®, or Nook® configured with mobile communication capabilities), and personal digital assistants (PDAs) with mobile communication capabilities, may also be provided with the novel contactless payment functionality as described herein.

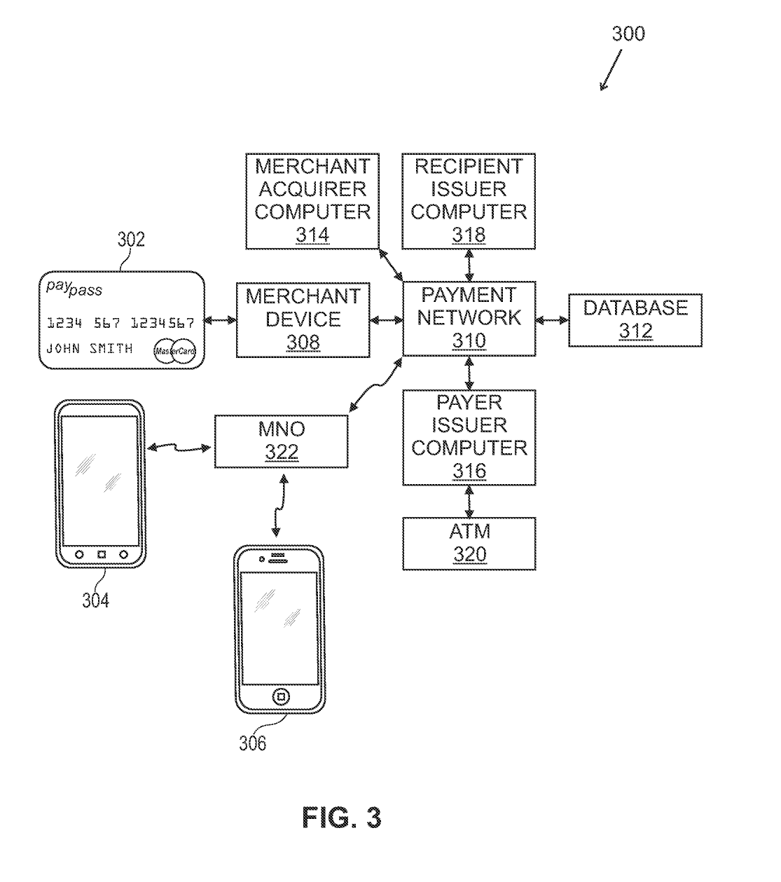

FIG. 3 is a block diagram of a transaction handling system 300 according to an embodiment. The transaction handling system includes a payment device 302 (which may be a proximity payment device or any other type of payment device configured as disclosed herein), payment enabled mobile telephones 304 and 306, a merchant device 308 (for example, a point-of-sale (POS) terminal), a payment network 310 (which may be the well-known Banknet™ system operated by the assignee hereof, for routing payment transactions between financial institutions), a database 312 operably connected to the payment network 310, a merchant acquirer computer 314 (which issued the merchant's financial account), a payer issuer computer 316 (which issued a financial account to a first consumer), a recipient issuer computer 318 (which issued a financial account to a second consumer), an automatic teller machine (ATM) 320 associated with the payer issuer computer 316, and a mobile network operator (MNO) computer 322 (which is operable to receive and to direct wireless communications between the mobile telephones 304 and 306 and to communicate with the payment network 310). It should be understood that each of the blocks 308, 310, 314, 316, 318 and 322 may represent one or more computers or computer systems and/or other electronic components.

In some implementations, a consumer or customer (not shown) desiring to load the reserve purse (not shown), for example contained in the payment device 302, inserts the payment device into a card reader (not shown) of the ATM 320. In some implementations, the ATM 320 prompts the consumer to enter a password or to follow some other security protocol that may involve one or more passwords or other type(s) of security data. Upon successful entry of the password(s) and/or security data, the ATM communicates with the consumer's issuer computer 316 (which represents, for example, a bank that issued a financial account which can be used to provide value to the reserve purse of the electronic wallet contained in the consumer's device). In some embodiments, at this point in the process, the consumer is presented with a menu of choices on a display screen (not shown) of the ATM. For example, the display screen can display a list of different types of currency that may be used and an input field for the consumer to indicate an amount of money that the consumer wishes to load. For example, the display screen of the ATM 320 may prompt the consumer to first select a type of currency in one of Dollars (United States), Euros (European Union), Pound Sterling (United Kingdom), Yen (Japan), Yuan (China), Ruble (Russia), Rupees (India), Real (Brazil), Australian Dollar or the Canadian Dollar, and then to provide an amount in an amount field. The consumer may utilize a keypad (not shown) of the ATM to input an amount of money (a value) into the amount field which indicates the value (an amount in a selected of currency) to be loaded into the reserve purse of the electronic wallet in the consumer's device (illustrated by FIG. 3 as the payment device 302). The selection of a currency type may depend upon the location of the customer (who, for example, may have traveled to a foreign country and thus wishes to select the currency of that country). After making his or her currency and amount selections (and complying with any security data input requirements), and upon validation of any security code or other security measure(s), the ATM loads value into the reserve purse of the proximity payment device 302 which is immediately available for the consumer to spend.

In the case of a consumer using a payment enabled mobile telephone 304, in some embodiments a load application that has been downloaded into that mobile telephone (which may occur during a personalization process) is accessed by the consumer when the consumer desires to load value into his or her electronic wallet. In an implementation, the load application is operable to present the consumer with a menu of choices on the display screen of the mobile telephone with a plurality of currency types and an amount field, in a manner similar to that described above. However, prior to selecting a currency type and indicating an amount to load, the consumer may be required to enter a password (which may be, for example, a mobile personal identification number (mPIN)) and/or complete a security protocol. Upon successful completion of the security protocol, the consumer makes his or her currency type selection and enters an amount, and then the load application transmits a message to the payment network 310 via the MNO 322 with that information. The payment network then routes the request to the consumer's issuer financial institution (for example, the payer issuer computer 316) and if all is in order (i.e., the consumer's financial account contains the necessary funds to cover the load request) then the payment network 310 provides an authorization message and instructions for the requested amount of value in the selected currency type to be loaded into the reserve purse of the electronic wallet resident on the consumer's mobile telephone 304.

In both of the load request scenarios described above, the consumer's payment device (the proximity payment device or the payment enabled mobile telephone) goes “online”, which means connects to the consumer's issuer computer to first obtain authorization to load his or her payment enabled electronic device, and then to receive value in the reserve purse which can then be used to purchase merchandise or to pay for services. During these load processes, the consumer's payment device may also provide an indication of the value (if any) contained in the received purse of the consumer's payment device to the payment network 310 (which may include further information regarding the source of the funds contained in the received purse such as data identifying a payer, data indicating the time and date of the transaction, data indicating the payer's financial institution, and the payer's financial account number). If value is contained in the received purse, the payment network 310 functions to clear the transaction by sending an authorization request to the payer's issuer computer 316 and notification to the recipient issuer computer 318 reporting the amount of value that was transferred between a first consumer's payment device and a second consumer's payment device. For example, a first consumer may perform a payment transaction by transferring value from the reserve purse of his mobile telephone directly to the received purse of a second consumer's mobile telephone via the MNO 322. Later, when the second consumer's mobile telephone is online, for example, to request loading from the second consumer's issuer bank, the payment network 322 receives information and/or data concerning the value in the received purse. The payment network 322 then routes an authorization request to the first consumer's issuer bank (the payer issuer computer) and if an authorization message from the payer's issuer computer 316 is received, then the payment network may function to send a message to the second consumer's payment device indicating that the amount of the transfer has been approved along with instructions for the value to be transferred from the received purse on the second consumer's payment device to the reserve purse, which enables the second consumer to spend that amount of money. In addition, the process includes the payer issuer computer 316 providing payment to the recipient issuer computer 318 (the second consumer's issuer bank) for the value of the transferred amount of money in the requested currency.

With regard to a purchase transaction between a consumer and a merchant, in some embodiments the consumer initiates the purchase transaction by visiting a retail store (not shown) operated by the merchant and selecting goods or items (not shown) that she wishes to purchase. The consumer then carries the selected goods to a checkout counter that includes a POS terminal (the merchant's device 308). The consumer presents her proximity payment device 302 (or payment enabled mobile telephone 306) that includes an integrated circuit (IC) or chipset that permits use as a wireless (contactless or contact) payment device. As mentioned above, the consumer's proximity payment device includes a mobile wallet having a reserve purse storing value in a currency that can be utilized for consumer transactions. The mobile wallet includes information associated with a consumer financial account (such as a payment card account) at an issuer financial institution. In some implementations, the consumer taps the proximity payment device 302 on a proximity reader (not shown) associated with the merchant's POS terminal 308 to initialize communications. Value is then transferred from the reserve purse of the consumer's proximity payment device 302 to the POS terminal 308 along with consumer information. The POS terminal (and thus the merchant) accepts the payment, and in some implementations at a later time transmits an authorization request to the payment network 310 (for example, in a batch process at the end of the day which includes a plurality of purchase transaction data concerning many different purchase transactions). The purchase authorization request typically includes consumer information and purchase transaction details, including the amount of the transaction. The payment network then conducts a clearing transaction by contacting the payer issuer computer 316 and the merchant acquirer computer 314 that issued the merchant's account. If all is in order (and there should be no problem as the value in the reserve purse of the consumer's payment device has been already been approved by the payer issuer computer at some point), the acquirer computer 314 transmits an authorization response which is routed to the POS terminal 308 via the payment network 310 indicating a successful payment. Payment is also transmitted from the payer issuer computer 316 to the merchant acquirer computer 314 for crediting to the merchant's account. Thus, in some cases the confirmation of a successful payment is received well after the consumer has left the retail store with the merchandise, and thus use of the system by merchants relies on trust in the entity or entities sponsoring and/or controlling the system, such as a payment card system organization like MasterCard International Inc. In particular, the security and integrity of the system would be recognized by the branding utilized (for example, the logo of a trusted payment network provider may be provided on the merchant's POS terminal or other merchant device and/or on IC payment cards utilized by consumers), in the same manner as trust in a currency of a particular country depends on the strength of the national bank that underwrites it.

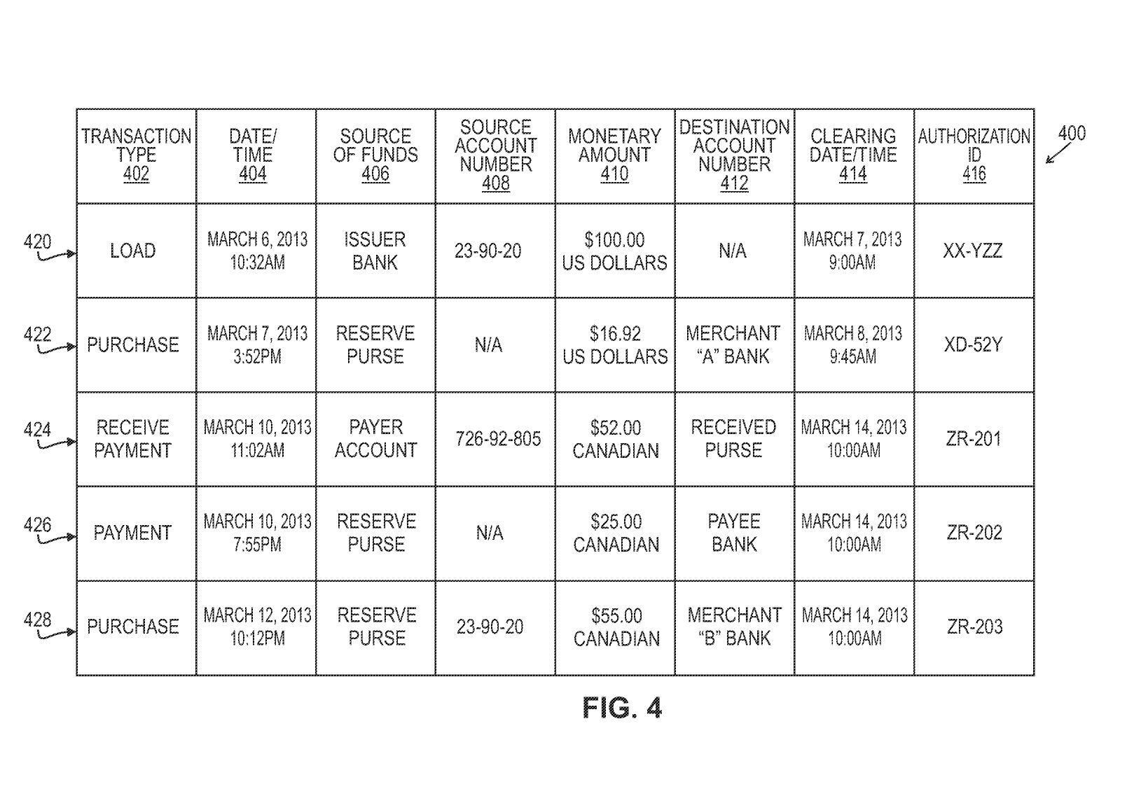

FIG. 4 is a table 400 illustrating examples of data associated with the reserve purse and the received purse of a particular consumer's electronic wallet with regard to various types of transactions according to an embodiment. In particular, the data may be contained in the database 312 (shown in FIG. 3) regarding various types of transactions that have occurred involving the electronic wallet of a particular consumer. Referring to FIG. 4, the table 400 includes a transaction type column 402, a date and time column 404, a source of funds column 406, a source account number column 408, a monetary amount column 410, a destination account number column 412, a clearing date and time column 414, and an authorization identifier column 416. Shown in the first row 420 is an example of the data concerning a Load transaction (column 402) that occurred on Mar. 6, 2013 (column 404) involving the consumer's electronic wallet. The source of funds (column 406) for the Load transaction was the consumer's issuer bank, the source account number listed is 23-90-20 (column 408), and the value loaded was in the monetary amount of $100 US dollars (column 410). Since there is no destination account number (the destination is the electronic wallet's reserve purse), the term N/A (Not Applicable) is shown, and the clearing date and time (column 412) was Mar. 7, 2013 at 9:00 AM. An authorization identifier (column 414) of XX-YZZ was given to the Load transaction.

Shown in the second row 422 is an example of the data concerning a Purchase transaction (column 402) that occurred on Mar. 7, 2013 at 3:52 PM (column 404) involving the consumer's electronic wallet. In particular, the source of funds (column 406) for the Purchase transaction was the reserve purse of the consumer's electronic wallet, which does not have an account number so the Source Account Number (column 408) field is shown as N/A. The Purchase transaction was for the Monetary Amount of $16.92 US dollars (column 410), and the Destination Account (column 412) was the Merchant A bank. The clearing date and time (column 414) was Mar. 8, 2013 at 9:45 AM, and the authorization identifier (column 416) provided was XD-52Y.

Shown in rows 424, 426 and 428 are a “Receive payment” transaction, a “Payment” transaction and a “Purchase” transaction, respectively. These three transactions all occurred at different dates and/or times (see column 404 of each row), but have the same clearing date and time (see column 414 of each row) of Mar. 14, 2013 at 10:00 AM. This occurred because the consumer went online at that time to his or her issuer financial institution in order to load the electronic wallet and/or to transfer value from the received purse to the reserve purse. In particular, with reference to columns 402 and 410, the Load transaction of row 420 resulted in the $100 US dollars being loaded into the reserve purse, but the transactions in rows 422, 426 and 428 all acted to deplete the value of the reserve purse by $16.92 US dollars, $25.00 Canadian dollars and $55.00 Canadian dollars, respectively. Thus, the reserve purse at this time has about $13.00 US dollars left in it (taking into account that the exchange rate between Canadian dollars and US dollars at the time of these transactions was approximately one to one). The amount of $52.00 Canadian dollars is in the reserved purse of the electronic wallet, but this monetary value cannot be used by the consumer (with his or her electronic payment device) until it is transferred to the reserve purse. Thus, the consumer may request transfer of the $52.00 dollars to the reserve purse and/or a Load transaction to increase the monetary value of the reserve purse.

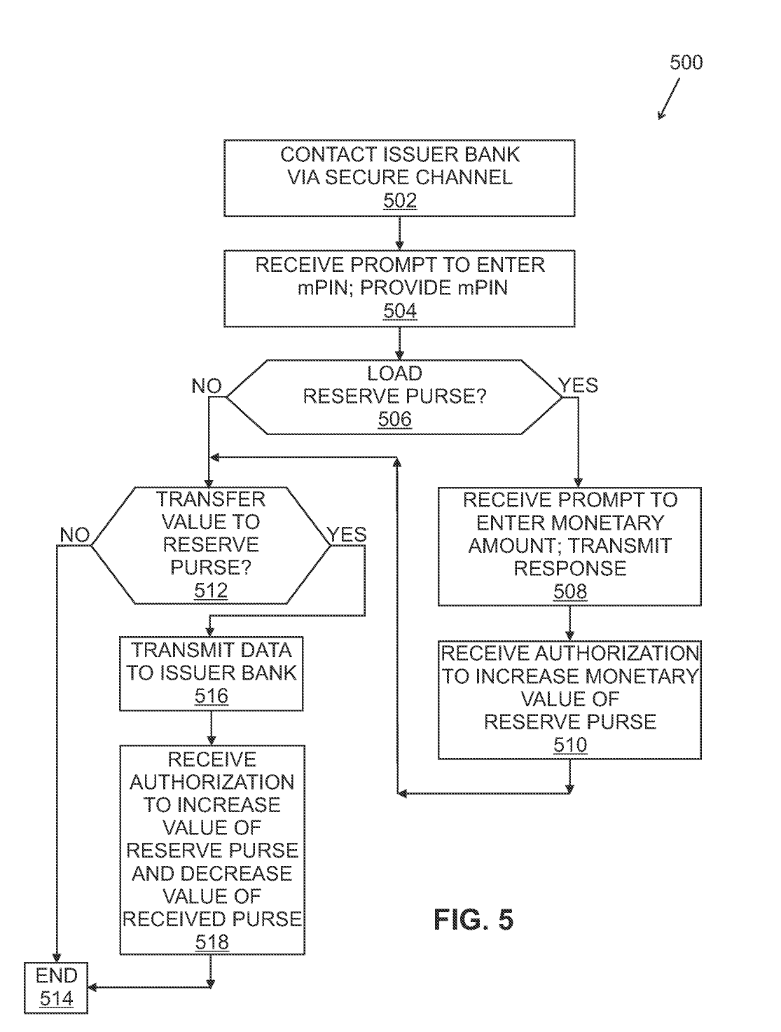

FIG. 5 is a flowchart 500 that illustrates a process for requesting the loading of monetary value and/or the transfer of monetary value to a reserve purse of an electronic wallet of a consumer according to an embodiment. The consumer, in some embodiments, utilizes his or her payment enabled electronic device (such as a mobile telephone) to contact 502 his or her issuer bank via a secure channel. The consumer then receives 504 a prompt from the issuer bank, which may be displayed for example on the display of the consumer's payment enabled mobile telephone, to enter a mobile personal identification number (mPIN). The consumer provides the mPIN and then is queried 506 to determine if the consumer wishes to conduct a Load transaction. If so, then the consumer receives 508 a prompt to enter a monetary amount (which may be in the form of a menu or menus that request selection of a currency type and a value). The consumer makes his or her selection(s) and transmits a response, and then receives 510 an authorization to increase the monetary value (if all is in order with the consumer's financial account) of the reserve purse by the requested amount.

The consumer may next be prompted 512 regarding transfer of value from the received purse (if any value is stored therein) to the reserve purse. If the consumer replies “No” (for example, the consumer is aware that there is no value in the received purse), then the process ends 514. However, if the consumer replies “Yes” to the query in step 512, then data including a monetary amount is transmitted 516 from the consumer's payment device to the issuer bank. The data may include, for example, information regarding the source of the monetary value (for example, the funds may have been transferred from a reserve purse of a second consumer's electronic wallet resident in the second consumer's payment device) and data to enable the consumer's issuer bank to receive value from another financial institution (for example, data identifying a second consumer's financial institution). Since the consumer has already entered his or her mPIN (in step 504), the consumer's mobile payment device receives 518 authorization to increase the value of the reserve purse by the amount that was stored in the received purse. At the same time, the amount of value in the received purse is decreased by the requested amount (which may be in the form of a script that includes executable instructions for allowing value to be loaded into the reserve purse and removed from the received purse). In some embodiments, the consumer requests transfer of all of the value stored in the received purse to the reserve purse, in which case the stored value in the received purse is deleted. The process then ends 514.

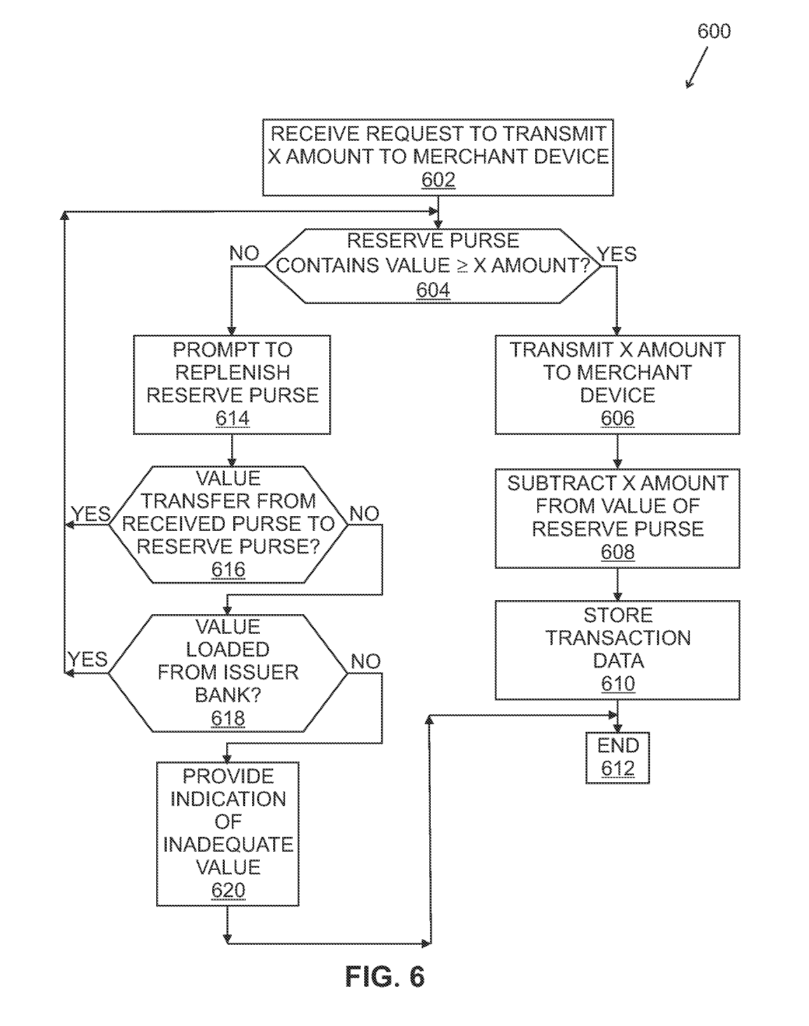

FIG. 6 is a flowchart 600 that illustrates a process for conducting a payment transaction by transmitting a monetary value from a reserve purse of a consumer's electronic wallet to a merchant device according to an embodiment. A payment application stored in a memory device of a consumer's payment enabled mobile telephone receives 602 a request to spend “X amount” of monetary value by transmitting that amount to a merchant device. The payment application checks 604 to see if the reserve purse contains value that is equal to or greater than “X amount”. If so, then “X amount” of value is transmitted 606 to the merchant device, X amount is subtracted 608 from the value present in the reserve purse, and purchase transaction data is saved 610 to an electronic wallet database. The purchase transaction data may include information identifying the destination account (or the merchant device), the amount transmitted or spent, and the date and time of the transaction. The process then ends 612.

However, if in step 604 the reserve purse does not contain “X amount” required to consummate the purchase transaction, then the consumer is prompted 614 to replenish the reserve purse. As explained above, the consumer may conduct a Load transaction or may conduct a transfer of value transaction (from the received purse to the reserve purse) or do both by going online and contacted the consumer's issuer bank. The process then continues after a predetermined time has elapsed with the payment application checking 616 to see if value has been transferred from the received purse to the reserve purse. If so, then the process branches back to step 604 to see if the reserve purse contains value greater than or equal to X amount. If the value in the reserve purse is still less than X amount, then the consumer will again be prompted 614 to replenish the reserve purse. However, if in step 616 no value was transferred from the received purse to the reserve purse, then the payment application checks 618 to see if a Load transaction occurred. If so, the process again branches back to step 604 to check that enough value has been loaded to consummate the purchase transaction. However, if there was no value transferred from the received purse or a Load transaction (or if the value added to the reserve purse by either type of transaction was inadequate), then the consumer is provided 620 with an indication on his or her mobile device that there are inadequate funds in the reserve purse for the purchase transaction and the process ends 612.

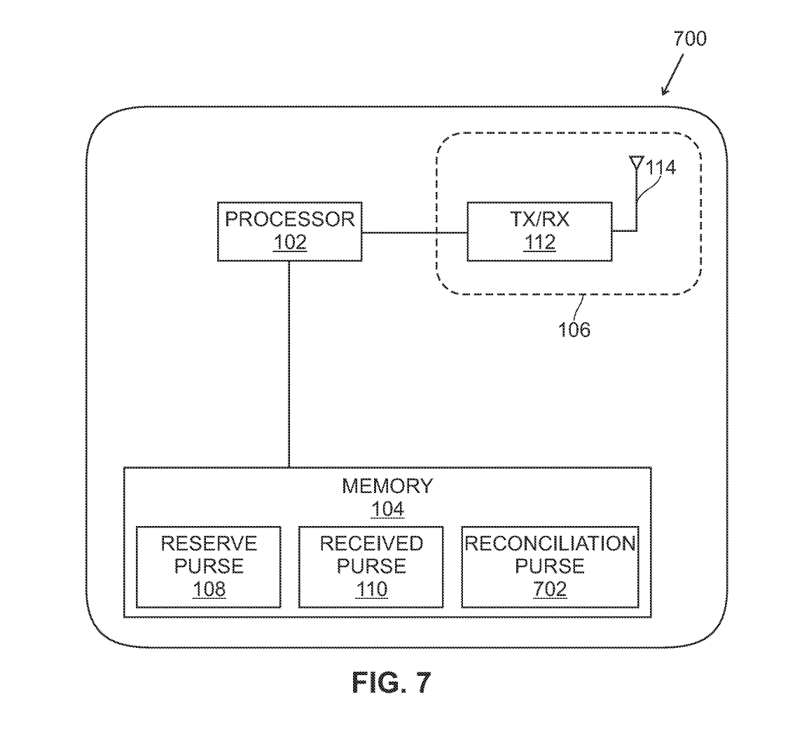

FIG. 7 illustrates is a schematic block diagram of a proximity payment device 700 according to some embodiments. The proximity payment device 700 includes similar components with regard to the payment device 100 shown in FIG. 1, and thus like components have the same reference number. In addition, the proximity payment device 700 may be sized and shaped like a conventional credit card or debit card, and may be made out of plastic or another type of material or of a composite material.

Referring to FIG. 7, the proximity payment device 700 includes a processor 102, at least one storage device 104, and a wireless communication interface 106. The wireless communication interface 106 allows the proximity payment device 700 to transmit and/or to receive signals. In some embodiments, wireless communication interface 106 includes transmit/receive circuitry 112 and an antenna 114 that may be configured to transmit and receive radio frequency (RF) signals. The antenna 114 may be a loop antenna and/or any other suitable configuration. The transmit/receive circuitry 112 may be coupled between the antenna 114 and the processor 102, and signals transmitted by the wireless communication interface 106 may include a payment account number and/or other information stored in the memory or storage device 104. The signals received by the wireless communication interface may include an interrogation signal, a power signal and/or other signals. In some embodiments, the wireless communication interface 106 may be configured to allow the proximity payment device 700 to operate in accordance with the above-mentioned “PayPass™” standard.

Referring again to FIG. 7, in some embodiments the storage device 104 may be configured to store a payment account number and/or other information required for entering into transactions, for example, a purchase transaction with a POS terminal of a merchant. In addition, the storage device may store one or more application programs and/or computer-readable instructions configured to instruct the processor to perform functions in accordance with the methods described herein. In some embodiments, the processor 102 may be a secure microcontroller. The reserve purse 106, received purse 108 and reconciliation purse 702 may also be contained within one or more secure storage portions of the memory or storage device 104. The processor may also be configured to execute one or more pre-defined mobile payment device programs or applications stored within the storage device 104.

In operation, wireless signals (for example, RF signals) may be received by the antenna 114 and supplied to the transmit/receive circuitry 112, which in response may provide signals that are supplied to the processor 102. The processor 102 may also provide signals that are supplied to the transmit/receive circuitry 112, which in response may provide signals that are supplied to the antenna 114 for wireless transmission to, for example, a reader device associated with a POS terminal.

In some embodiments, the processor 102, storage device 104 and the transmit/receive circuitry 112 are disposed in a single integrated circuit (IC), and in some embodiments form a radio frequency identification (RFID) IC. For example, the processor 102, storage device 104 and transmit/receive circuitry 112 may be disposed in an IC that uses NFC technology, such as an NFC IC provided by PHILIPS ELECTRONICS or NXP Semiconductors.

Unless stated otherwise, the term RFID is not limited to a specific type of RFID. In some embodiments, an RFID may be a memory device capable only of responding to a pre-defined set of commands. In some other embodiments, an RFID may comprise a microcontroller capable of executing a program. Some embodiments may include further features and/or may comprise other configurations altogether. In some embodiments, the RFID IC comprises an IC that uses contactless technology.

In the payment device embodiment 700 of FIG. 7, the storage device 104 includes memory space that is partitioned into three separate storage facilities: a reserve purse 108, a received purse 110, and a reconciliation purse 702. The reserve purse 108 is operable to store value which may be loaded from an issuer bank in an amount of a predefined currency. The reserve purse 108 may be utilized by a consumer to purchase goods or services, or may be used to transfer an amount of currency to another consumer. The received purse 110 is operable to store value received from third party entities, such as an amount of currency received from a payment device of another consumer. In some implementations, the reconciliation purse 702 is operable to accumulate and/or store charge values imposed by financial institutions that accrue whenever an off-line transfer occurs. For example, in some implementations when the consumer's proximity payment device 700 transfers value offline to a second consumer's payment device, a reconciliation charge accrues that will be assessed by the consumer's issuing bank for the offline transaction when the consumer's proximity payment device 700 next goes online to reconcile the offline transactions that have occurred. In such cases, value may be transferred from the reserve purse 108 to the reconciliation purse 702 as offline transactions occur to cover the reconciliation charges that will be assessed when the consumer's proximity payment device 700 next goes online and connects with a payment network. Thus, when the consumer's proximity payment device 700 next goes online, in some implementations the balance or a portion thereof in the reconciliation purse 702 is sent directly to the party or parties that charge reconciliation fees and that amount is subtracted from the reconciliation purse.

In an alternate configuration, the reconciliation purse 702 keeps a tally of the amounts transferred offline that would need to be added to the next online transfer of funds between purses or from the received purse 110 to a bank account. Thus, when the consumer's proximity payment device 700 next goes online the tally present in the reconciliation purse 702 causes value to be transferred from one of the reserve purse 108 or the received purse 110 directly to the party or parties that charge reconciliation fees.

It should be understood that transactions other than offline transactions may also occur that result in value being added to, or subtracted from, the reconciliation purse 702, or that cause the reconciliation purse to keep a tally for the purposes of later providing value to one or more third party entities.

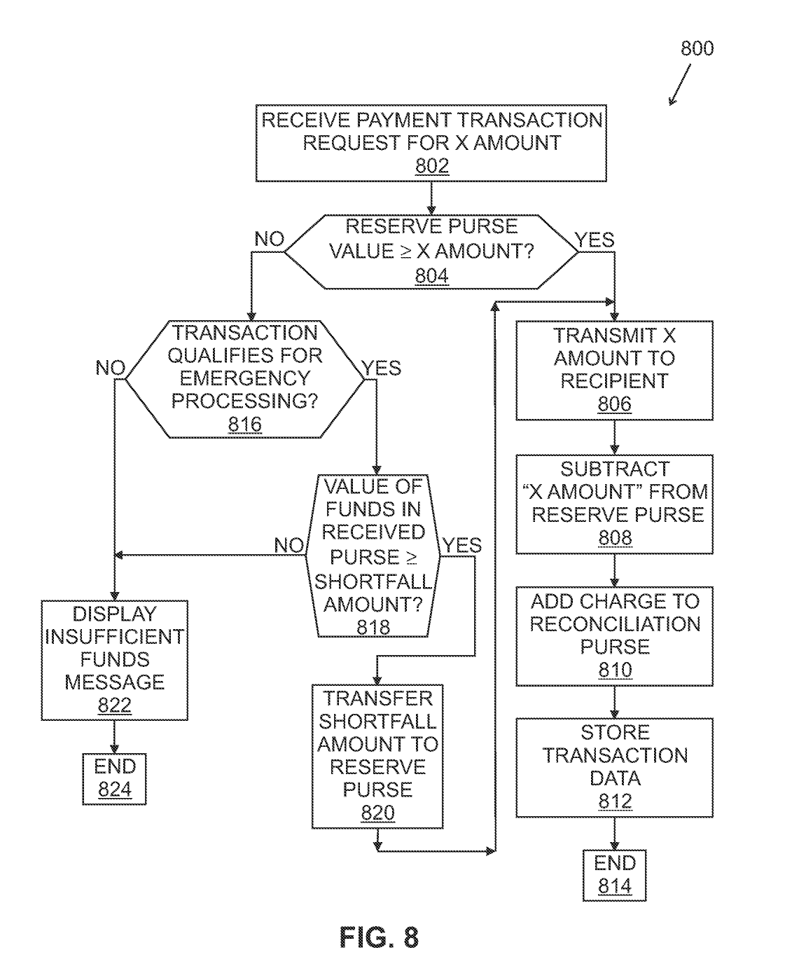

FIG. 8 is a flowchart 800 that illustrates an embodiment of a process for conducting an offline payment transaction. The consumer's payment device receives 802 a payment transaction request to transmit an amount equal to a monetary value of “X amount” to, for example, a recipient's mobile device. (For ease of understanding, the term “X amount” can be understood to include the monetary value payable to the recipient plus any reconciliation charge amount that may accrue that would be payable to, for example, an issuer bank when the consumer's payment device next goes online.) A payment application in the consumer's device operates to check 804 if the reserve purse contains value that is equal to or greater than “X amount”. If so, then “X amount” of value is transmitted 806 to the recipient's device, that amount is subtracted or transferred 808 from the value present in the reserve purse, and a reconciliation charge amount is added 810 to the reconciliation purse in the consumer's payment device. In some embodiments, the reconciliation charge amount may be subtracted from or transferred from the reserve purse, and the reconciliation charge amount may be equal to a reconciliation charge value imposed by a financial institution to cover the offline payment transaction and/or an offline purchase transaction. The reconciliation charge value that is stored in the reconciliation purse may be equivalent to the sum of the charges for each of the offline payment transactions and/or offline purchase transactions that have occurred since the consumer last went online to communication with his or her issuer bank. Thus, the total reconciliation charge amount stored in the reconciliation purse may be equivalent to the charges that are incurred during an online reconciliation process involving transfers of funds, and therefore such a process ensures that an issuer bank, for example, is never out-of-pocket regarding transaction fees that may accrue when the consumer is transacting offline. Transaction data may also be stored 812 before the process ends 814. The transaction data may include information identifying each payee's payment device, each recipient's account (the destination account) associated with each payment and/or purchase transaction, the amount(s) transmitted or spent, the nature of each transaction, and the date and time of each transaction. The process then ends 814.

As explained earlier herein, when the consumer's device next goes online to connect to a payment network, then the balance in the reconciliation purse may be transmitted to, for example, the issuer bank and/or the payment system and/or other entity to cover the transaction and/or reconciliation fees that have accrued during offline transactions entered into by the consumer since the consumer last went online.

Referring again to FIG. 8, if the processor in the consumer's payment device determines 804 that the reserve purse contains less than “X amount” (i.e., a value less than the amount in the payment transaction request), then the payment application in the consumer's device operates to check 816 if the transaction qualifies for “emergency” processing. A transaction may qualify for emergency processing if, for example, the shortfall amount (wherein the shortfall amount equals “X amount” minus the value currently stored in the reserve purse) is less than a predetermined amount, or such a determination may be based on other criteria. In the embodiment of FIG. 8, once a determination is made in step 816 that the transaction qualifies for emergency processing, then the payment application determines 818 if adequate funds exist in the received purse to cover the shortfall amount. If the value of the received purse is greater than or equal to the shortfall amount, then the shortfall amount is transferred 820 from the received purse to the reserved purse. Next, “X amount” is transmitted 806 to the recipient device for the payment transaction and that amount is subtracted 808 from the reserve purse. In some implementations, a charge is added 810 to the reconciliation purse (which may be an emergency transaction fee and/or emergency reconciliation fee that may be a predetermined amount set, for example, by an issuer bank and/or the payment processor and/or other entity), and transaction data is stored 812 before the process ends 814. The transaction data may include information identifying the destination account (and/or the payee's device), the amount transmitted or spent, information concerning the nature of the emergency, and the date and time of the transaction. Regarding the information concerning the nature of the emergency, in some embodiments the consumer is required to provide information about the nature of the emergency by keying in information by utilizing his or her mobile device, or by using a keyboard associated with a point of sale (POS) terminal, for example. The nature of the emergency data may be utilized by, for example, the issuer bank to ensure that the emergency facility is not being abused by the consumer.

It should be understood that a transaction may also qualify for “emergency” processing based on many different types of considerations and/or characteristics that may be associated with a transaction, such as if a payment transaction is for services rendered by a hospital or other medical care provider. Other qualifying events and/or circumstances may be predefined by, for example, an issuer bank and/or the consumer and/or a third party entity that would permit payment transactions (and/or a purchase transactions) to be consummated even though the reserve purse in the payment device does not contain enough value to cover that transaction, whether or not the received purse has enough value stored therein to cover the shortfall amount.

Referring again to FIG. 8, if in step 816 the transaction does not qualify for emergency processing or if a determination is made in step 818 that the received purse does not contain enough value to cover the shortfall amount, then an insufficient funds message is displayed 822, for example, on a display screen of the consumer's payment device or on a display associated with a POS terminal. The process then ends 824.

With regard to the flowcharts provided herein, it should be understood that the illustrated methods are not limited to the order shown. Rather, embodiments of the methods may be performed in any order that is practicable. For that matter, unless stated otherwise, any method disclosed herein may be performed in any order that is practicable. Notably, some embodiments may employ one or more portions of the methods illustrated herein without one or more other portions of the methods.

As used herein and in the appended claims, the term “payment card account” includes a credit card account or a deposit account that the account holder may access using a debit card. The term “payment card account number” or “financial account number” includes a number that identifies a payment card account or a number carried by a payment card, or a number that is used to identify an account in a payment system that handles debit card and/or credit card transactions or to route a transaction in a payment system that handles debit card and/or credit card transactions. The term “payment card” includes a credit card or a debit card (including a pre-paid debit card). The term “payment card account” also includes an account to which a payment card account number is assigned. Thus a payment card account may include an account to which payment transactions may be routed by a payment system that handles debit card and/or credit card transactions, even if the account in question is not eligible to be charged for purchase transactions or other transactions. A payment card account may also include an account from which payment transactions may be routed by a payment system that handles debit card and/or credit card transactions, even if the account in question is not customarily used, or is not eligible, to be charged for purchase transactions.

Although the present invention has been described in connection with specific exemplary embodiments, it should be understood that various changes, substitutions, and alterations apparent to those skilled in the art can be made to the disclosed embodiments without departing from the spirit and scope of the invention as set forth in the appended claims.

1. A method, comprising:
receiving, by a payment device from an issuer bank computer, a value for use in conducting offline transactions;
storing the value in a reserve purse of an electronic wallet;
receiving, by the payment device from a second payment device, a second value;
storing, by the payment device, the second value in a received purse of the electronic wallet; and
transmitting, by the payment device, at least a portion of the value stored in the reserve purse to one of a merchant device to consummate an offline purchase transaction or to a consumer payment device to consummate an offline payment transaction.

2. The method of claim 1, further comprising, prior to receiving the value from the issuer bank computer:
transmitting, by the payment device to an issuer bank computer, a request to load value into the reserve purse;
receiving, by the payment device, a request to provide a personal identification number (PIN); and
transmitting, by the payment device to the issuer bank computer, the requested PIN.

3. The method of claim 2, wherein the payment device comprises a mobile device and the PIN is a mobile personal identification number (mPIN).

4. The method of claim 1, wherein the payment device comprises a mobile device.

5. The method of claim 4, wherein the mobile device comprises at least one of a mobile telephone, an integrated circuit (IC) card, a laptop computer, a tablet computer, an e-Book reader, and a personal digital assistant.

6. The method of claim 1, further comprising, subsequent to storing the second value in the received purse:
transmitting, by the payment device to an issuer bank computer, a request to transfer at least a portion of the second value from the received purse to the reserve purse;
receiving, by the payment device from the issuer bank computer, a request to provide a personal identification number (PIN);
transmitting the requested PIN to the issuer bank computer; and
receiving, by the payment device from the issuer bank computer, instructions to cause the payment device to increase a value in the reserve purse by the at least a portion of the second value.

7. The method of claim 6, further comprising, receiving instructions configured to cause the payment device to decrease the second value stored in the reserved purse by an amount equal to the at least a portion of the second value.

8. The method of claim 6, wherein the payment device comprises a mobile device and the PIN is a mobile personal identification number (mPIN).

9. A method, comprising:
receiving, by a payment device from a recipient device, a request to consummate an offline transaction for a monetary amount;
determining, by the payment device, that a value stored in a reserve purse is adequate to cover the monetary amount and a reconciliation charge amount, wherein the reconciliation charge amount is equal to a reconciliation charge value imposed by a financial institution to cover the offline transaction;
transmitting, by the payment device to the recipient device, the monetary amount and subtracting the monetary amount from the value in the reserve purse; and
transferring, by the payment device, the reconciliation charge amount from the reserve purse to a reconciliation purse.

10. The method of claim 9, further comprising storing, by the payment device, offline transaction data.

11. The method of claim 10, wherein the offline transaction data comprises information identifying the recipient device, a recipient account, the monetary amount, the nature of the offline transaction, and the date and time of the offline transaction.

12. The method of claim 10, further comprising transmitting, by the payment device to an issuer bank computer, the offline transaction data and the reconciliation charge amount from the reconciliation purse.

13. The method of claim 9, further comprising, subsequent to receiving the request to consummate an offline transaction:
determining, by the payment device, that the value stored in the reserve purse is inadequate to cover the monetary amount;
determining, by the payment device, that the offline transaction qualifies for emergency processing;
determining, by the payment device, a shortfall amount equal to the monetary value of the offline transaction plus a reconciliation charge amount minus the value stored in the reserve purse;
determining, by the payment device, that a value stored in a received purse is adequate to cover the shortfall amount, and transferring a value equal to the shortfall amount from the received purse to the reserve purse;
transmitting, by the payment device to the recipient device, the monetary amount and subtracting the monetary amount from the value stored in the reserve purse; and
transferring, by the payment device, a reconciliation charge amount from the reserve purse to a reconciliation purse, wherein the reconciliation charge amount is equal to a reconciliation charge value imposed by a financial institution to cover the offline transaction.

14. The method of claim 13, further comprising:
storing, by the payment device, offline transaction data; and
transmitting, by the payment device to an issuer bank computer, the offline transaction data and the reconciliation charge amount from the reconciliation purse.

15. The method of claim 14, wherein the offline transaction data comprises information identifying the recipient device, a recipient account, the monetary amount, the nature of the emergency, and the date and time of the offline transaction.

16. The method of claim 13, wherein the offline transaction qualifies for emergency processing when the shortfall amount is less than a predetermined amount.

17. The method of claim 13, wherein the offline transaction qualifies for emergency processing when the offline transaction comprises services rendered by at least one of a hospital and a medical care provider.

18. A non-transitory computer-readable medium storing instructions configured to instruct a processor to:
receive a value for use in conducting offline transactions from an issuer bank computer;
store the value in a reserve purse of an electronic wallet;
receive a second value from a second payment device;
store the second value in a received purse of the electronic wallet; and
transmit at least a portion of the value stored in the reserve purse to one of a merchant device to consummate a purchase transaction or to a consumer payment device to consummate a payment transaction.

19. The non-transitory computer-readable medium of claim 18, further comprising, prior to the instructions for receiving a value from the issuer bank computer, instructions configured to cause the processor to:
transmit to the issuer bank computer, a request to load value into the reserve purse;
receive a request to provide a personal identification number (PIN); and
transmit to the issuer bank computer the requested PIN.

20. The non-transitory computer-readable medium of claim 18, further comprising, subsequent to the instructions for storing the second value in the received purse, instructions configured to cause the processor to:
transmit a request to an issuer bank computer to transfer at least a portion of the second value from the received purse to the reserve purse;
receive a request from the issuer bank computer to provide a personal identification number (PIN);
transmit the requested PIN to the issuer bank computer; and
receive from the issuer bank computer, instructions to cause the payment device to increase a value in the reserve purse by the at least a portion of the second value.

21. The non-transitory computer-readable medium of claim 20, further comprising instructions configured to cause the processor to decrease the second value stored in the reserved purse by an amount equal to the at least a portion of the second value.

22. A non-transitory computer-readable medium comprising instructions configured to cause a processor to:
receive a request to consummate an offline transaction for a monetary amount from a recipient device;
determine that the value stored in a reserve purse is adequate to cover the monetary amount and a reconciliation charge amount, wherein the reconciliation charge amount is equal to a reconciliation charge value imposed by a financial institution to cover the offline transaction;
transmit the monetary amount to the recipient device and subtract the monetary amount from the value in the reserve purse; and
transfer the reconciliation charge amount from the reserve purse to a reconciliation purse.

23. The non-transitory computer-readable medium of claim 22, further comprising instructions configured to instruct the processor to store offline transaction data.

24. The non-transitory computer-readable medium of claim 23 further comprising instructions configured to instruct the processor to transmit the offline transaction data and the reconciliation charge amount from the reconciliation purse to an issuer bank computer.

25. The non-transitory computer-readable medium of claim 22, further comprising, subsequent to the instructions for receiving the request to consummate an offline transaction, instructions configured to instruct the processor to:
determine that the value stored in the reserve purse is inadequate to cover the monetary amount;
determine that the offline transaction qualifies for emergency processing;
determine a shortfall amount equal to the monetary value of the offline transaction plus a reconciliation charge amount minus the value stored in the reserve purse;
determine that a value stored in a received purse is adequate to cover the shortfall amount, and transfer a value equal to the shortfall amount from the received purse to the reserve purse;
transmit the monetary amount to the recipient device and subtract the monetary amount from the value stored in the reserve purse; and
transfer a reconciliation charge amount from the reserve purse to a reconciliation purse, wherein the reconciliation charge amount is equal to a reconciliation charge value imposed by a financial institution to cover the offline transaction.

26. The non-transitory computer-readable medium of claim 25, further comprising instructions configured to instruct the processor to:
store offline transaction data; and
transmit the offline transaction data and the reconciliation charge amount from the reconciliation purse to an issuer bank computer.

27. An apparatus comprising:
a processor;
a non-transitory computer readable medium operably connected to the processor, the non-transitory computer readable medium comprising a reserve purse and a received purse and storing instructions configured to instruct the processor to:
receive, from an issuer bank computer, a value for use in conducting offline transactions;
store the value in the reserve purse of the storage device;
receive, from a second payment device, a second value;
store the second value in a received purse of the storage device; and
transmit at least a portion of the value stored in the reserve purse to one of a merchant device to consummate a purchase transaction or to a consumer payment device to consummate a payment transaction.

28. The apparatus of claim 27, wherein the non-transitory computer readable medium further comprises a reconciliation purse; and
wherein the non-transitory computer readable medium stores instructions configured to instruct the processor to:
receive a request to consummate an offline transaction for a monetary amount from a recipient device;
determine that the value stored in a reserve purse is adequate to cover the monetary amount and a reconciliation charge amount, wherein the reconciliation charge amount is equal to a reconciliation charge value imposed by a financial institution to cover the offline transaction;
transmit the monetary amount to the recipient device and subtract the monetary amount from the value in the reserve purse; and
transfer the reconciliation charge amount from the reserve purse to the reconciliation purse.
